(19) United States
(12) Patent Application Publication
(10) Pub. No.: US 2019/0337829 A1
(43) Pub. Date: Nov. 7, 2019

(54) ANAEROBIC SEQUENCING BATCH REACTOR COVER

(71) Applicant: The Board of Regents for Oklahoma State University, Stillwater, OK (US)

(72) Inventor: Douglas Wayne Hamilton, Stillwater, OK (US)

(73) Assignee: The Board of Regents for Oklahoma State University, Stillwater, OK (US)

(21) Appl. No.: 16/403,986

(22) Filed: May 6, 2019

Related U.S. Application Data
(60) Provisional application No. 62/666,975, filed on May 4, 2018.

(51) Int. Cl. C02F 3/28

(52) U.S. Cl. CPC C02F 3/282; C02F 2203/006

(57) ABSTRACT

There is provided herein a roof for a reactor vessel that utilizes a weighted floating cover. The cover is free to move up and down within the vessel as the fluid level changes during the operational cycle. In some embodiment, the cover itself is not directly connected to the reactor vessel or its sidewall, but instead is held in place and supported from above by truss-like support members that permit movement of the cover in concert with the changing fluid level in the vessel. In an embodiment, the support members are anchored proximate to the top of the reactor vessel.

### CROSS REFERENCE TO RELATED APPLICATIONS

This application claims the benefit of U.S. Provisional Patent Application Ser. No. 62/666,975 filed on May 4, 2018, and incorporates said provisional application by reference into this document as if fully set out at this point.

### TECHNICAL FIELD

This disclosure relates generally to biomass reactors and, more specifically, to covers for anaerobic sequencing batch reactors.

### BACKGROUND

Anaerobic Sequencing Batch Reactors (“ASBR”), or alternatively ASBR digesters, are able to achieve high levels of treatment of low-solids, high strength wastewaters by retaining an active biomass in the reactor while operating at Hydraulic Retention Times (HRT, i.e., the average amount of time liquids remain in reactor) on the order of 4 to 6 days.

ASBR digesters are a low-cost option for treating any low-solids, high energy wastewater. For example, this sort of digester can be used for mixtures of biodiesel production wastewaters, food processing wastes, hydrolyzed domestic and municipal wastes, brewery wastewaters, flushed human waste and animal manures, etc.

In a conventional ASBR reactor, solids are retained by sequencing the gas tight reactor through an operational cycle consisting of four phases (FIG. 4). Note that the triangular pointers in this and other diagrams generally indicate the fluid level or the interface between liquid and gas in the vessel. As can be seen in this figure, wastewater is added to the partially emptied reactor during the fill phase which, as might be expected, raises the fluid level in the reactor. Maximum contact between active biomass and wastewater is made by mixing the reactor contents during the react phase according to methods well known to those of ordinary skill in the art. Biomass is allowed to settle towards the bottom of the reactor during the settle phase. Effluent is decanted off the top of the settled solids in the decant phase. In practice, ASBRs are generally operated with one to three cycles per day (8 to 24 hours per cycle) depending on wastewater characteristics.

An ASBR is a high rate digestion system that retains microflora in the reactor by sequentially feeding influent, mixing the reactor, settling solids, and decanting effluent from the top of the reactor. ASBR reactors are highly efficient (e.g., up to 0.55 m³ CH₄ kg⁻¹ VS methane yields, 80 to 95% influent to decant organic matter reduction efficiencies), and are ideal for treating liquid waste streams containing low concentrations of suspended solids such as effluent from hydrolysis reactors. For example, working with liquid swine manure, researchers in North America have found that, by judiciously removing sludge at regular intervals, Solids Retention Time (SRT, i.e., the average time solids are held in the reactor) may be held much longer than 30 days, while operating at a HRT as short as 4 to 5 days.

The simple method of separating liquid from settled solids provides superior quality effluent. Since decanting is decoupled from feeding, the problem of intermittent loads of high solids influent washing out microflora experienced with Upflow Sludge Blanket (USB) reactors is eliminated. ASBR digesters have a much smaller footprint and have more efficient nutrient removal schedules than Covered Lagoon digesters.

If the quantity of suspended solids leaving the reactor during the decant phase is low, the SRT can be separated from (and ideally made much longer than) HRT. A high SRT means slow-growing methane producing microorganisms are retained in the reactor long enough to reproduce, even if the reactor has an extremely short HRT. Reactor size is directly related to HRT. In other words, a reactor with high SRT is able to reduce organic matter better than one with a low SRT; low HRT reactors are smaller than high HRT reactors, making them less expensive to build and operate.

As popular and versatile as these reactors are, they are subject to certain problems. The potential niche for ASBR digesters is currently being filled by more complex and expensive Attached-Growth and Upflow Anaerobic Sludge Blanket (UASB) reactors. These sorts of digesters are also problematic to operate. They can be completely disabled if a slug of high solids wastewater passes through the reactor. The potential to replace attached-growth and UASB with ASBR is enormous, but very few ASBR digesters have been built to date.

Even with these apparent advantages over other digestion technologies, very few anaerobic sequencing batch reactors are operating outside of laboratory situations. Among others, two problems have contributed to this situation.

First, there have been construction problems in designing reactors that accommodate the fluctuating pressure within the reactor. The falling and rising liquid level during the decant and fill phases acts like a piston inside the ASBR and tends to separate tops from reactor vessels. Digesters with rigid roofs can fail due to cracking in the sidewall, and detachment of the rigid roof from the sidewall. Attempts to remedy this problem with a simple, flexible membrane roof have generally failed due to leaking membrane and detachment of the membrane from the sidewall.

Additionally, poor decant quality is often experienced due to difficulties settling retained solids when large masses of solids are carried in the reactor, thereby tending to limit the length of SRT and reducing Organic Matter Loading Rates (OLR). The settling rate of the expanded sludge bed during the settle phase is directly related to concentration of retained solids in the bed. Retained solids concentration needs to be sufficiently high to maintain SRT. Decanting in current ASBR designs rely on removing liquid at a fixed point in the reactor vessel. If the solids cannot settle beyond this fixed point, suspended solids will be carried out of the digester. The limitations associated with completely separating SRT from HRT have been well documented in the literature, as has the ability to attain organic matter reduction levels in practice that are achievable in a laboratory studies.

As such, what is needed is an improved ASBR which does not suffer the limitations of the prior art.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

An embodiment of a self-contained floating cover and operating system for Anaerobic Sequencing Batch Reactor (ASBR) digesters that combines the functions of an ASBR in one package, while substantially improving on current ASBR designs. As such, there is provided herein a roof for a reactor vessel that utilizes a weighted floating cover. The cover is designed to be free to move up and down within the vessel as the fluid level changes during the operational cycle. In some embodiment, the cover itself is not directly connected to the reactor vessel or its sidewall, but instead is held in place and supported from above by truss-like support members that are free to move vertically by means of casters contained in a “C” channel to permit movement of the cover in concert with the changing fluid level in the vessel. In an embodiment, the support members are anchored proximate to, but outside of, the top of the reactor vessel.

In various embodiments, a plurality of pass-through conduits penetrate the surface of the cover and extend downward into the ASBR tank. In some embodiments the conduits are affixed to the cover and are adapted to move up and down along with it. The conduits might serve functions such as providing for the release of gas from the cover, mixing the reactor with a jet, intake of clarified liquid above the expanded sludge bed for jet mixing, feeding, decanting, sampling, and sludge or scum removal. Such functionality is well known to those of ordinary skill in the art.

Advantages of various embodiments are numerous. For example, a constant pressure can be maintained in the reactor vessel using a weighted floating cover of the sort taught herein. Various embodiments are self-contained operational units. In operation, the functions of an embodiment of the instant digester operation are accomplished with the cover and a pump-valve-control building located above or to the side of the digester. The floating cover is supported externally, allowing a simple buried or free-standing tank, designed to withstand a constant bursting pressure, to serve as the reactor vessel.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 contains a schematic drawing of self-contained floating cover and operating system for an ASBR digester according to one embodiment.

FIG. 2 contains an exemplary approach to supporting the inventive cover.

FIG. 3 illustrates a top view of the embodiment of FIG. 2.

FIG. 4 illustrates some phases of a typical ASBR operational cycle.

FIG. 5 contains experimental results for one embodiment including the average quality of decanted effluent from five, 36 L ASBR reactors before (June-July) and after (November-December) switching from full to partial mixing schemes. Error bars indicate standard error at the 95% confidence level.

### DETAILED DESCRIPTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

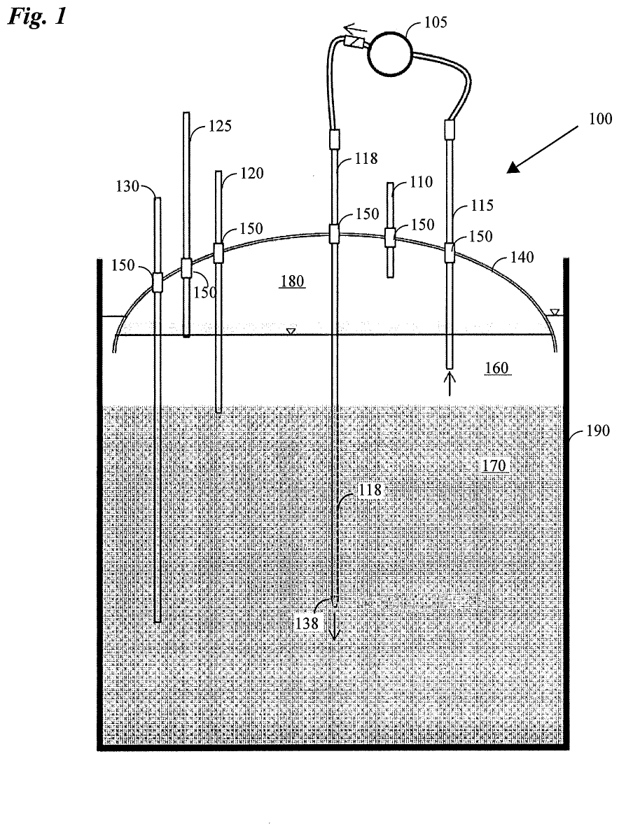

A schematic drawing of an embodiment of the cover 140 for use with ASBR Digesters is given in FIG. 1. According to one embodiment, the self-contained cover system 100 comprises a free floating cover 140 which is penetrated by a plurality of tubes 110-135 that pass through the cover and into the interior of the reactor vessel or tank 190. Note that one embodiment of a configuration of the cover 140 is in the shape of the concave structure of FIG. 1, i.e., it is generally dome-shaped with a rounded perimeter that generally conforms to the shape of the interior of the tank 190. However, in practice that shape is not an absolute requirement and any structure that would allow biogas 180 to be trapped and accumulated above the biomass 170 would potentially be suitable. Generally speaking, though, since most of the tanks 190 that are used in ASBR digesters are cylindrical, it would be best to match the general periphery of the cover 140 with that of the interior walls of the tank 190 in which it rests so as to cover as much of interior of the tank as possible. Thus, this suggests that the dome- or overturned bowl-shaped embodiment of FIG. 1 might be useful in many situations.

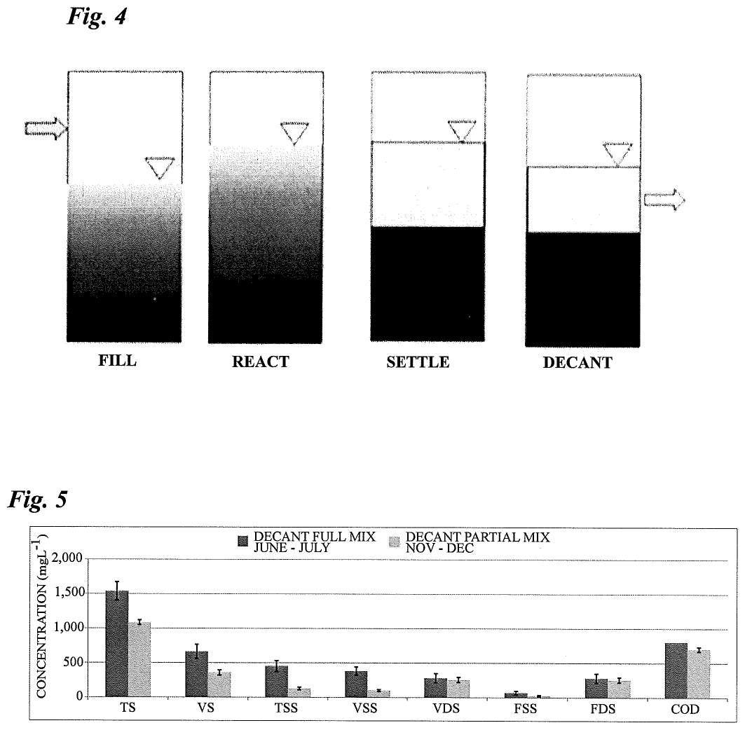

As can generally be seen in FIG. 1, this embodiment is free floating and not attached to the reactor vessel 190 sidewall. In operation, it is designed to rest atop the fluids in the vessel 190. As indicated previously, it is free floating so that it can move up and down during the changes in fluid level that result during the different phases of the ASBR's operational cycle (e.g., as illustrated in FIG. 4). Certain embodiments of the instant cover 140 might be made of coated steel, but those of ordinary skill in the art will recognize that there are many other materials that could be used depending on the particular ASBR reactor and the preferences of the designer.

Turning now to a discussion of the embodiment FIG. 1 in greater detail, in this figure an embodiment 100 comprises a cover 140 designed to be free floating in an ASBR in a tank 190. In this particular case, mixing pump 105 is configured to draw clarified liquid 160 from above the expanded sludge bed via jet mixing intake line 115 and then inject it deep within the sludge 170 via injection line 118 which typically terminates in a jet mixing nozzle 138. Conduit 110 is a biogas release tube which allows trapped biogas 180 to be withdrawn or vented from under the cover 140. The decant can be withdrawn via decant withdrawal conduit 120. Surface scum that might tend to accumulate atop the decant liquid can be removed using scum removal conduit 125 and sludge 170 can be withdrawn via sludge removal conduit 130.

As is further indicated in FIG. 1, each conduit will preferably be enclosed by a conduit sleeve 150 as it passes through the cover 140, with each of the conduit sleeves 150 being sized to allow the respective conduit to be moved up and down within it. That is, in certain embodiments each sleeve 150 can be loosened to allow the terminus of its respective conduit to be positioned at any depth relative to the cover 140. In some embodiments the sleeves 150 will contain “0” rings so that an airtight seal can be created between the sleeve 150 and the conduit it encloses. Preferably this seal will be effective whether the sleeve 150 is in a locked (tightened) or unlocked (loosened) configuration.

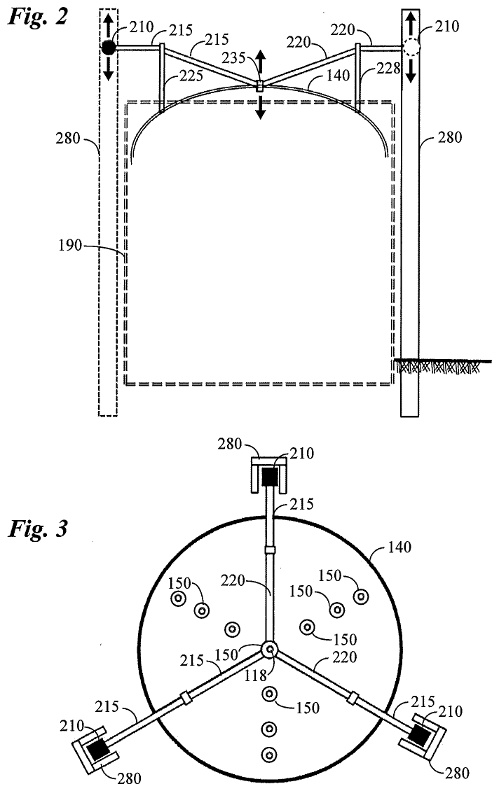

FIGS. 2 and 3 contain further aspects of an embodiment. In the cross-sectional view provided by FIG. 2, one possible approach to supporting and guiding the cover 140 as it rises and falls within the reactor vessel 190 is disclosed. As can be seen, in this variation the cover 140 is free floating within tank 190 and is affixed (perhaps removably) or otherwise in mechanical communication with vertical support arms 225 and 228. Each vertical support arm 225 and 228 is in mechanical communication at one end with one of the lateral support arms 215 and 220, respectively, and at the other end with the cover 140. The arms 215, 220, 225, and 228 are rigid and are designed to guide and support guide the cover 140 as it moves up and down within the tank 190. Note that in the claims that follow, it should be understood that when it is said that one component is “connected” to another, that language should be broadly construed to include instances with the two components are both joined to a third component and not directly connected or attached to each other.

Continuing with the present embodiment, lateral support arms 215 and 220, which are affixed or otherwise in mechanical communication at one end with the cover 140, preferably at connector 235, t are free to move vertically guided by the rolling casters 210 which are situated within vertical “C” channels 280. This configuration allows the instant cover 140 to respond to and accommodate the up and down motion that is occasioned by the changing fluid level in the reactor tank 190 during its operational cycle.

Note that in the embodiment of FIG. 2 the weight of the cover 140 is at least partially supported and guided externally by “C” channels 280 which are different from the walls of the tank 190. This has obvious structural advantages as compared with prior art approaches which attach the cover 140—directly or indirectly—to the tank 190 itself. Preferably, the cover 140 will not have weight bearing support from the tank 190.

FIG. 3 contains a top down/plan view of the embodiment of FIG. 2. In this figure the arrangement of the casters 210 within “C” channels 280 can be seen more readily for this embodiment. In this figure, each “C” channel 280 partially encloses its respective caster 210 and otherwise allows the caster 210 to move up and down unimpeded. Of course, although a caster and “C” channel combination is suggested as one embodiment of a roller ad guide that would be suitable for use with the instant embodiment, those of ordinary skill in the art will recognize that many other configurations could be devised. As such, when the terms “caster” and “vertical roller guide” are used in the claims that follow those terms should be broadly construed to include any feasible combination of rollers and guides that limit the associated roller to vertical movement.

Additionally, FIG. 3 contains an illustration of one possible spatial arrangement of the conduits 110 to 130 is shown as represented by the locations of the sleeves 150. That is, since the positioning and number of the different conduits 110 to 130 that penetrate the cover 140 is generally not critical, the pattern of conduits in this figure is given as a simple example of how such might be arranged in order to provide the functionality necessary to operate the ASBR system. That being said, although the number and positions of the various conduits may be varied arbitrarily to suit a particular installation, there is a minimum level of functionality that must be provided by these conduits and such is described in greater detail below.

In practice, the liquid level in the tank 190 is controlled by the decant and feeding pumps which are activated by a timer and moderated through feedback signals received from the vertical position of the cover 140, which is free to move up and down as the fluid level changes. Such arrangements are common and need not be explained here, as they are well within the knowledge of one of ordinary skill in the art.

In the embodiment of FIG. 3, the number and function of the individual conduits is not critical as long as they collectively provide for the seven basic functions necessary for operation of an ASBR reactor: i.e., releasing gas from the cover, mixing the reactor with a jet, removal of clarified liquid above the expanded sludge bed for jet mixing, feeding, decanting, sampling, and removing sludge and scum. The need for such functionality is well known to those of ordinary skill in the art. In this figure, the mixing/feeding conduit is centrally located and the other conduits dispersed spatially around it, however that was done for purposes of convenience and to balance the mass of the cover 140 rather than out of any kind of necessity.

In FIG. 1, the conduits can be seen to perform the seven basic functions identified above. That is, a conduit provides for the release of gas from the cover (e.g., conduit 110), another is for mixing of the reactor (e.g., conduit 118), the intake of clarified liquids above the expanded sludge bed for mixing is handled by another (e.g., conduit 115), feeding is accomplished by e.g., conduit 118, decanting is enabled via conduit 120, sampling can be performed via e.g., either of conduits 125 and 130, scum removal is made available via conduit 125, and sludge removal can be conducted via, e.g., conduit 130

In addition, note that the number of pass-through conduits might be reduced by using some of them for more than one purpose. For example, feeding and mixing could be combined to use a single jet. The same conduit could be used as an intake for both mixing intake and decanting. Also, the sampling tube(s) (125/130) could also be used for sludge removal. In another variation, each of the key functions might be performed by more than one conduit. For example, two or more conduits might be used for mixing intake or decanting to increase the flow while minimizing disturbance of the cloud of solids below. Such arrangement are well known to those of ordinary skill in the art.

Various mechanisms useful in the operations of an ASBR digester (e.g., pumps, valves, etc.) that are routinely situated external to the cover system 100 are not pictured in FIG. 1. Those of ordinary skill in the art will readily know where such might be situated and how they are used in practice.

The method of forming a gas tight seal underneath the cover 140 while allowing for complete vertical adjustment relative to the cover and locking of the conduit positions is one aspect of an embodiment that is not disclosed by prior art ASBR covers. The method of feeding, controlling reactor liquid level, and preventing spillage when the instant cover is utilized is also unique to this invention.

That is, the height of sludge blanket expansion during the react phase can be regulated by adjusting position of the jet mixing nozzle, nozzle size, and flow rate through the nozzle. Entrainment and crushing of suspended solids in the mixing pump during the react phase is avoided in this embodiment by raising the mixing withdrawal point above the top of the expanded sludge blanket (FIG. 1).

With respect to one particular embodiment, two experiments were performed to compare reactor performance under full and partial mixing schemes when used with an embodiment of the instant invention. All reactors were fed a mixture of liquid swine manure and glycerol. Full mixing is the traditional method of operating an anaerobic sequencing reactor (ASBR). Partial mixing is one aspect of this invention.

The full mix reactor(s) were vigorously mixed using a single point liquid jet mixer so that the entire reactor had homogenous solids concentration. Liquid was removed from the mid-point of the reactor and reentered the reactor through a nozzle pointed towards the bottom of the reactor. Suspended solids entrained in the liquid passed through a centrifugal pump and the nozzle before returning to the reactor.

The partial mix reactor(s) were also mixed using a single point liquid jet mixer; however, mixing intensity was reduced so that a cloud of suspend solids only partially filled the reactor. Liquid used for mixing was removed from above the suspended solids cloud and reentered the reactor through an identical nozzle pointed towards the bottom of the reactor. Suspended solids were not entrained in the liquid stream used to mix the reactor.

In the first experiment, two 36 L reactors were simultaneously operated using the same operating conditions. One reactor had full mixing, the other partial mixing. Results are given in Table 1 below.

In the second experiment, five 36 L reactors were operated using identical operating conditions under the full mixing scheme, and were switched to the partial mixing scheme under similarly identical operating conditions. The test results are given in Table 2. Full mix results were measured during the 6 weeks immediately prior to the switch to partial mixing. Partial mix results were measured during a 6-week period, four months (8 Hydraulic Retention Times, HRT) after the switch to partial mixing.

Both experiments show that a greater mass of Volatile Suspended Solids (VSS), and thus active biomass, was retained in the reactors under partial mixing. Solids Retention Time (SRT, the mass of VSS retained in the reactor divided by VSS leaving the reactor each day) increased by a factor of 4 to 10 under the partial mix scheme. This result tends to demonstrate that various embodiments will increase retention of biota in the reactor.

Reactor stability, measured as pH at the end of the react phase, is statistically similar under both mixing schemes. Volatile Fatty Acid Concentration (VFA) increased with partial mixing. This is due to the greater mass of biologically active solids retained in the reactor. The ratio of VFA to Bicarbonate Alkalinity (VFA:HCO₃ Alk); did not reach critical values (0.6 VFA:HCO₃ Alk measured in mmol), however.

Reactor performance measured in biogas production, biogas yield per mass of organic matter (OM, measured as Volatile Solids (VS) and Chemical Oxygen Demand (COD)) added, and organic matter removal increased under partial mixing compared to full mixing. These two results support the claim that various embodiments would increase digester performance without affecting stability.

Perhaps one of the greatest and most beneficial effects of changing from full to partial mixing is the increase in effluent quality. FIG. 5 shows effluent quality as measured by concentration of Total Solids (TS), Volatile Solids (VS), Total Suspended Solids (TSS), Volatile Suspended Solids (VSS), Volatile Dissolved Solids (VDS), Fixed Suspended Solids (FSS), Fixed Dissolved Solids (FDS), and COD of decanted effluent leaving the reactors in the second experiment. Mass of total organic matter (VS), and especially suspended organic matter (VSS), received by treatment components downstream of the digester is greatly reduced with use of this invention.

TABLE 1
Comparison of two 36 L reactors simultaneously operated under identical feeding
and cycling conditions using full and partial mixing schemes.

| | | Full Mix Reactor 5 | | | Partial Mix Reactor 6 | | |
|---|---|---|---|---|---|---|---|
| | | Jun. 15-Jul. 22, 2015 | | | Jun. 15-Jul. 22, 2015 | | |
| | | n | X | sd | n | X | sd |
| Operational | HRT (days) | | 15 | | | 15 | |
| | Calculated SRT¹ (days) | | 54 | | | 280 | |
| | Feeding Cycle Length | | 12 | | | 12 | |
| | (hours) | | | | | | |
| | OLR (g VS L⁻¹ day⁻¹) | | 0.155 | | | 0.155 | |
| | OLR (g COD L⁻¹ day⁻¹) | | 0.30 | | | 0.30 | |
| Reactor | pH² | 6 | 7.9 | 0.073 | 6 | 8.0 | 0.080 |
| Stability | VFA² (mmol L⁻¹) | 3 | 0.38 | 0.29 | 6 | 2.8 | 1.7 |
| | VFA: HCO₃ Alkalinity² | 3 | 0.0071 | 0.0048 | 6 | 0.050 | 0.034 |
| Biogas | Average Rate (L day⁻¹) | | 6.5 | | | 6.8 | |
| Production | VRE (L Biogas L⁻¹ | | 0.22 | | | 0.23 | |
| | Reactor day⁻¹) | | | | | | |
| | Biogas Yield (L g⁻¹ VS | | 1.4 | | | 1.5 | |
| | Added) | | | | | | |
| | Biogas Yield (L g⁻¹ COD | | 0.73 | | | 0.77 | |
| | Added) | | | | | | |
| OM | VS Removal Efficiency | | 73 | | | 79.5 | |
| Removal | (%) | | | | | | |
| | COD Removal Efficiency | | 79 | | | 88 | |
| | (%) | | | | | | |

¹Neglecting Solids Removed for Sampling
²Measured at End of React Phase

TABLE 2
Comparison of five, 36 L reactors operated under similarly identical feeding and
cycling conditions before and after switching from full to partial mixing schemes.

| | | | | | Partial Mix | | |
|---|---|---|---|---|---|---|---|
| | | Full Mix | | | Reactors 1-5 | | |
| | | Reactors 1-5 | | | Nov. 16-Dec. 20, | | |
| | | Jun. 15-Jul. 22, 2015 | | | 2015 | | |
| | | n | X | sd | n | X | sd |
| Operational | HRT (days) | | 15 | | | 15 | |
| | Calculated SRT¹ (days) | | 53 | | | 610 | |
| | Feeding Cycle Length | | 12 | | | 12 | |
| | (hours) | | | | | | |
| | OLR (g VS L⁻¹ day⁻¹) | | 0.155 | | | 0.155 | |
| | OLR (g COD L⁻¹ day⁻¹) | | 0.30 | | | 0.31 | |
| Reactor | pH² | 30 | 7.85 | 0.094 | 30 | 7.7 | 0.091 |
| Stability | VFA² (mmol L⁻¹) | 7 | 0.49 | 0.36 | 24 | 3.8 | 2.19 |
| | VFA: HCO₃ Alk² | 7 | 0.0097 | 0.0069 | 24 | 0.078 | 0.042 |
| Biogas | Average Rate (L day⁻¹) | 5 | 6.8 | 2.9 | 5 | 8.3 | 2.5 |
| Production | VRE (L Biogas L⁻¹ | 5 | 0.23 | 0.0097 | 5 | 0.28 | 0.0093 |
| | Reactor day⁻¹) | | | | | | |
| | Biogas Yield (L g⁻¹ VS | 5 | 1.5 | 0.33 | 5 | 1.8 | 0.39 |
| | Added) | | | | | | |
| | Biogas Yield (L g⁻¹ COD | 5 | 0.76 | 0.084 | 5 | 0.90 | 0.097 |
| | Added) | | | | | | |
| OM | VS Removal Efficiency | | 71 | | | 85 | |
| Removal | (%) | | | | | | |
| | COD Removal Efficiency | | 79 | | | 89 | |
| | (%) | | | | | | |

¹Neglecting Solids Removed for Sampling
²Measured at End of React Phase

Various embodiments of the instant self-contained floating cover and operating system for ASBR Digesters addresses at least the following issues with prior art problems with ASBR Digesters.

Construction Problems Due to Fluctuating Pressure within the Reactor:

Since the floating cover rises and falls with liquid level, pressure under the bowl does not change. Biogas pressure can be set to meet the needs of downstream devices (H₂S filter, engine-generator, fuel cell, etc.) using a pressure regulating devise such as a water trap or spring-loaded pressure relief valve.

Poor Decant Quality Due to Difficulties Settling Retained Solids:

With various embodiments, position of decant withdrawal is fixed relative to the cover—rather than to the reactor (e.g., see FIG. 4). Removal of suspended solids during the decant phase is avoided by allowing the sludge blanket to settle past the withdrawal point's zone of disturbance during the settle phase. Once this point is reached, the decant phase can start, even as sludge continues to settle. Since the decant withdrawal point moves with the cover, and the cover moves with liquid level, the speed at which the withdrawal point moves downward is equal to speed at which the liquid level is lowered in the reactor (V_{c}=Vₗ). Suspended solids will not be pulled into the decant line if decant flow is adjusted so that the rate of the cover's fall is slower than the settling rate of the sludge blanket (V_{c}<Vₗ).

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. An anaerobic sequencing batch reactor, comprising:
(a) a generally cylindrical reactor tank having an interior, an interior wall, and an exterior;
(b) a free floating cover positionable to be within said reactor tank,
said cover having a perimeter that conforms to said interior wall,
said cover shaped to trap biogas from said tank within said interior,
said cover including a plurality of conduits passing therethrough, said plurality of conduits at least for performing the functions of releasing said biogas from said inner surface said cover, mixing the reactor content, removal of clarified liquid above the expanded sludge cloud for use in mixing, feeding, decanting, sampling, and sludge or scum removal; and,
(c) a plurality of lateral support arms, each of said plurality of later support arms being in mechanical on one end with said cover and on another end with a roller positionable to be within a corresponding vertical roller guide external to said reactor tank

2. The anaerobic sequencing batch reactor according to claim 1, wherein said plurality of conduits comprises:
(i) a least one mixing conduit in fluid communication with said reactor tank interior,
(ii) at least one mixing intake conduit in fluid communication with said reactor tank interior,
(iii) at least one feeding conduit in fluid communication with said reactor tank,
(iv) at least one decanting conduit in fluid communication with said reactor tank interior,
(v) at least one sampling conduit interior, and,
(vi) at least one conduit for removing sludge or scum from said reactor tank interior.

3. The anaerobic sequencing batch reactor according to claim 1, wherein each of said plurality of conduits extends through said cover an adjustable distance.

4. The anaerobic sequencing batch reactor according to claim 3, wherein each of said plurality of conduits passes through a lockable sleeve that acts to hold said conduit in place when locked and allows said conduit to move within said sleeve when unlocked.

5. The anaerobic sequencing batch reactor according to claim 1, wherein at least one of said rollers is a caster.

6. The anaerobic sequencing batch reactor according to claim 5, wherein each of said rollers is a caster and each of said vertical roller guide is a “C” channel.

7. The anaerobic sequencing batch reactor according to claim 1, wherein there are three or more lateral support arms.

8. An anaerobic sequencing batch reactor, comprising:
(a) a generally cylindrical reactor tank having an interior, an interior wall, and an exterior;
(b) a free floating cover positionable to be within said reactor tank,
said cover having a perimeter that conforms to said interior wall,
said cover shaped to trap biogas from said tank within said interior,
said cover including a plurality of conduits passing therethrough, said plurality of conduits at least for performing the functions of releasing said biogas from said inner surface said cover, mixing the reactor content, removal of clarified liquid above the expanded sludge cloud for use in mixing, feeding, decanting, sampling, and sludge or scum removal;
(c) a plurality of vertical roller guides situated external to said reactor tank;
(d) a same number of lateral support arm assemblies as vertical roller guides, each of said lateral support arm assemblies being in mechanical communication on a first end with said cover and on a second end with a roller, each of said rollers being positionable to be within a corresponding one of said vertical roller guides.

9. The anaerobic sequencing batch reactor according to claim 8, wherein said plurality of conduits comprises:
(i) a least one mixing conduit in fluid communication with said reactor tank interior,
(ii) at least one mixing intake conduit in fluid communication with said reactor tank interior,
(iii) at least one feeding conduit in fluid communication with said reactor tank,
(iv) at least one decanting conduit in fluid communication with said reactor tank interior,
(v) at least one sampling conduit interior, and,
(vi) at least one conduit for removing sludge or scum from said reactor tank interior.

10. The anaerobic sequencing batch reactor according to claim 8, wherein each of said plurality of conduits extends through said cover an adjustable distance.

11. The anaerobic sequencing batch reactor according to claim 10, wherein each of said plurality of conduits passes through a lockable sleeve that acts to hold said conduit in place when locked and allows said conduit to move within said sleeve when unlocked.

12. The anaerobic sequencing batch reactor according to claim 8, wherein at least one of said rollers is a caster.

13. The anaerobic sequencing batch reactor according to claim 12, wherein each of said rollers is a caster and each of said vertical roller guides is a “C” channel.

14. The anaerobic sequencing batch reactor according to claim 8, wherein there are three or more lateral support arm assemblies.

15. The anaerobic sequencing batch reactor according to claim 8, wherein each of lateral support arm assemblies comprises:
(d1) a lateral support arm, said lateral arm being in mechanical communication on a first end with said cover and on a second end with said roller, each of said rollers being positionable to be within a corresponding one of said vertical roller guides, and,
(d2) a vertical support arm, said vertical support arm connected at one end to said cover and connected at a second end to said lateral support arm.
